(19) United States
(12) Patent Application Publication
(10) Pub. No.: US 2008/0190692 A1
(43) Pub. Date: Aug. 14, 2008

(54) Ladder anchor

(76) Inventor: Frederick G. Feik, Maple Plain, MN (US)

Correspondence Address: WESTMAN CHAMPLIN & KELLY, P.A., SUITE 1400, 900 SECOND AVENUE SOUTH, MINNEAPOLIS, MN, 55402-3244, US

(21) Appl. No.: 11/705,210

(22) Filed: Feb. 12, 2007

(51) Int. Cl. E06C 7/06

(52) U.S. Cl. 182/107

(57) ABSTRACT

A ladder anchor is mounted to the side rails of a ladder and has jointed arms that are positioned on each side of the ladder and extend outwardly. The arms have arm sections that are capable of being positively adjusted as to their angular position, and which have support feet for engaging a wall surface of a building against which the ladder is placed.

### BACKGROUND

The present disclosure relates to a ladder anchor or stabilizer that attaches to a ladder and which will engage surfaces of a building against which the ladder is placed. The anchor can engage the side wall, under the eves or the roof of the building to provide stabilization.

Various ladder stabilizers and anchors have been provided, for example, there are devices that will anchor the lower end of the ladder by having a prong that sticks into the ground. These devices are to prevent the bottom of the ladder from sliding. Other stabilizers that engage the building roof or side walls have e been advanced as well, but have adjustment and operational drawbacks.

### SUMMARY

The present disclosure relates to a ladder anchor or stabilizer comprising a pair of arms that mount on opposite sides of a ladder, and which are jointed, so that they can be adjusted to position the ends of the anchor relative to a building surface to provide stability for the ladder.

The arms can be mounted onto the ladder in a variety of different ways, as shown, and the joint between arm sections provides for a quick adjustment, but a positive angular positioning of the arm sections relative to each other. The outer ends of the outer arm sections carry suitable feet or building surface engaging members.

In one aspect, the arms can be adjusted and moved so that they would be positioned underneath eves or soffitts of a building on which the ladder is placed, or against the upright wall of a building.

The present device is quickly adjusted, and positively positioned for use.

### BRIEF DESCRIPTION OF THE DRAWINGS

FIG. 1 is a fragmentary perspective view of a ladder that has walk through extensions thereon and the ladder anchors of the present disclosure in place;

FIG. 2 is an enlarged perspective of the ladder in FIG. 1 showing one side of the ladder carrying a ladder anchor;

FIG. 3 is a view similar to FIG. 2, except with the ladder anchor positioned to anchor against a soffit under the eves of a building;

FIG. 4 is a view similar to FIG. 3 with the ladder anchor positioned against an upright wall of a building on which the ladder is placed;

FIG. 5 is a fragmentary perspective view of a typical angular adjustment device for the ladder anchor components;

FIG. 6 is a fragmentary section view similar to FIG. 5 showing the ladder anchor angular adjustment device at joint between the arm sections;

FIG. 7 is an enlarged perspective view typical wall or roof engaging support used with the ladder anchor;

FIG. 8 is a front view of a ladder without walk through members having anchors made according to the present disclosure installed thereon;

FIG. 9 is a side elevational view of a bracket for attaching a ladder anchor arm to a ladder or walk through extension sleeve;

FIG. 10 is a sectional view taken generally along line 10-10 in FIG. 9;

FIG. 11 is a sectional view taken along line 11-11 in FIG. 9;

FIG. 12 is a top plan view of a ladder anchor in place and taken generally along line 12-12 in FIG. 10; and

FIG. 13 is a perspective view of a sleeve that fits over a ladder side rail and is extruded to integrally form a bracket for a ladder anchor.

### DETAILED DESCRIPTION OF ILLUSTRATIVE EMBODIMENTS

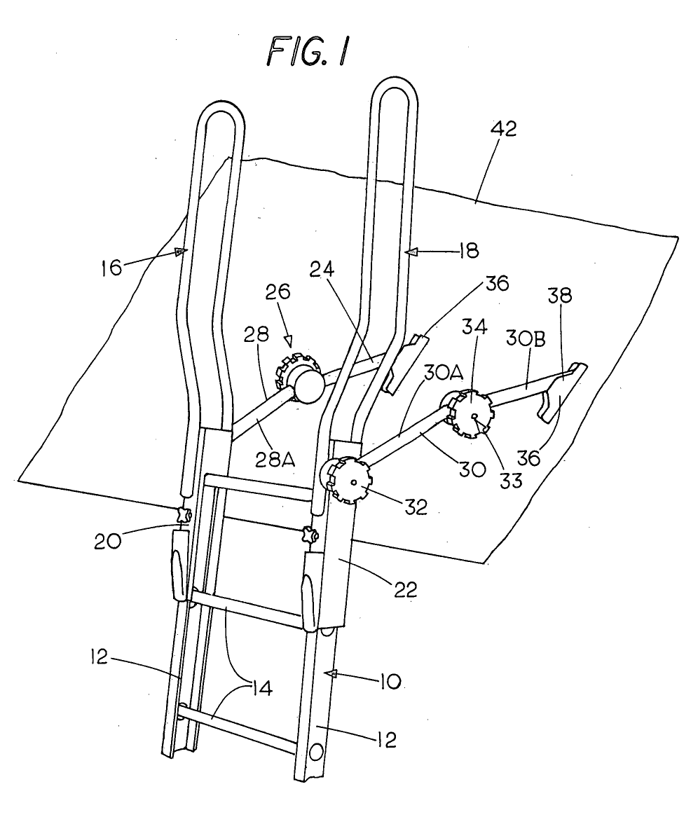

In FIG. 1, a typical ladder, which can be an extension ladder is indicated at 10, and has side rails 12, 12 joined with rungs 14. In this embodiment of the disclosure, the ladder 10 includes a pair of upright walk through extensions shown at 16 and 18, respectively, which fit over the upper portions of the respective side rails 12, 12 of the ladder. The walk through extensions include sleeves 20 and 22 that slip over the side rails 12 and which are securely supported at the upper end of the ladder 10.

It is to be understood of course that other types of ladders can be used with the present invention, and the ladder shown in FIG. 1 with the side wall extension, is disclosed in the inventors co-pending U.S. patent application Ser. No. 11/042,741, filed Jan. 25, 2005.

Ladders anchors made according to the present disclosure are illustrated generally at 26. There are two of the anchor assemblies, one for the left hand upright or rail 12 and one for the right upright or rail 12. The left hand ladder anchor arm is shown at 28, and the right hand ladder anchor arm is shown at 30.

Each of the anchor arms is made up of two arm sections. These arm sections are shown at 28A and 28B for the left hand ladder anchor arm 28 and at 30A and 30B for the right hand anchor arm 30. Illustratively, the details of the right hand anchor arm 30 will be illustrated. The base of arm section 30A has a manually, lockable, angularly adjustable lock assembly 32, mounted onto the sleeve 22 of the walk through extensions. The arm sections 30A and 30B are joined at a center joint or elbow joint 33 with a manually lockable, angularly adjustable operable lock assembly 34. The lock assemblies 32, 34 can be released to permit the arm sections to move about the axes of the lock assemblies, which are generally horizontal axes as disclosed.

The outer end of the outer arm sections 28B and 30B are each provided with a pivoting stabilizer foot assembly 36, that will be shown in greater detail, but is mounted to the outer end of the respective arm section about a pivot axis 38. The mounting can be a simple pivot pin, or other type of pivotal mounting so that the stabilizer foot 36 can seat on a wall or roof surface. The respective arm assembly (both arm sections) can be pivoted about the axis of the respective lock assembly 32 and at the elbow or center joint 34. The arm sections 28 and 30 can extend from the ladder at various angles.

In FIG. 1, a roof 42 is illustrated, and the foot supports 36 are seated against the roof 42 to stabilize the ladder against lateral sliding. As will be shown, the pivoting supports 36 can be anchored directly to the roof if desired.

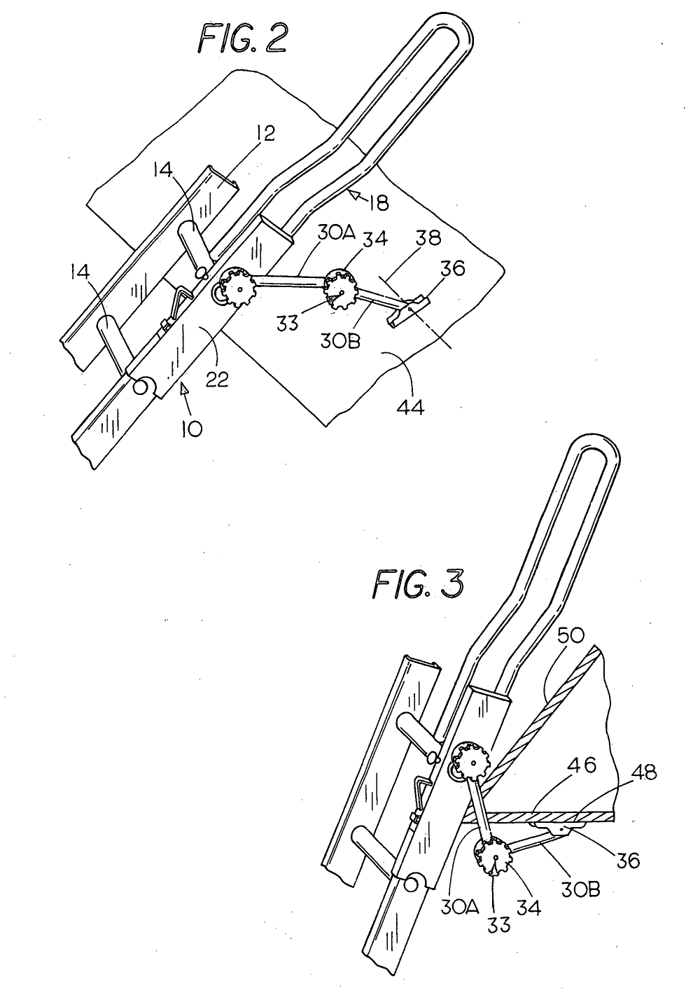

In FIG. 2, the parts are numbered identically, and in this form of the disclosure, the angles between the arm 30 and the ladder side rails, and between sections 30A and 30B have been changed to be supported on a roof 44. The roof mounting can be of any desired angle.

In FIG. 3, the arm sections 30A and 30B are rotated at the mounting point of attachment to the walk through attachment as shown, and the center joint at the pivot axis between the arm sections is moved so that the arm section 30B is underneath an eve board or soffit board 46. The foot support 36 is pivoted so that the base surface 48 is up against the bottom surface of the soffit, to provide stability to a ladder that is leaning against a roof 50, without having the foot support anchored or engaging the roof itself. The arm 28 would be positioned the same way. The foot supports 36 can be anchored to the soffit board in a suitable manner, and as will be shown, the foot supports 36 have apertures through which screws, nails, and the like can be driven.

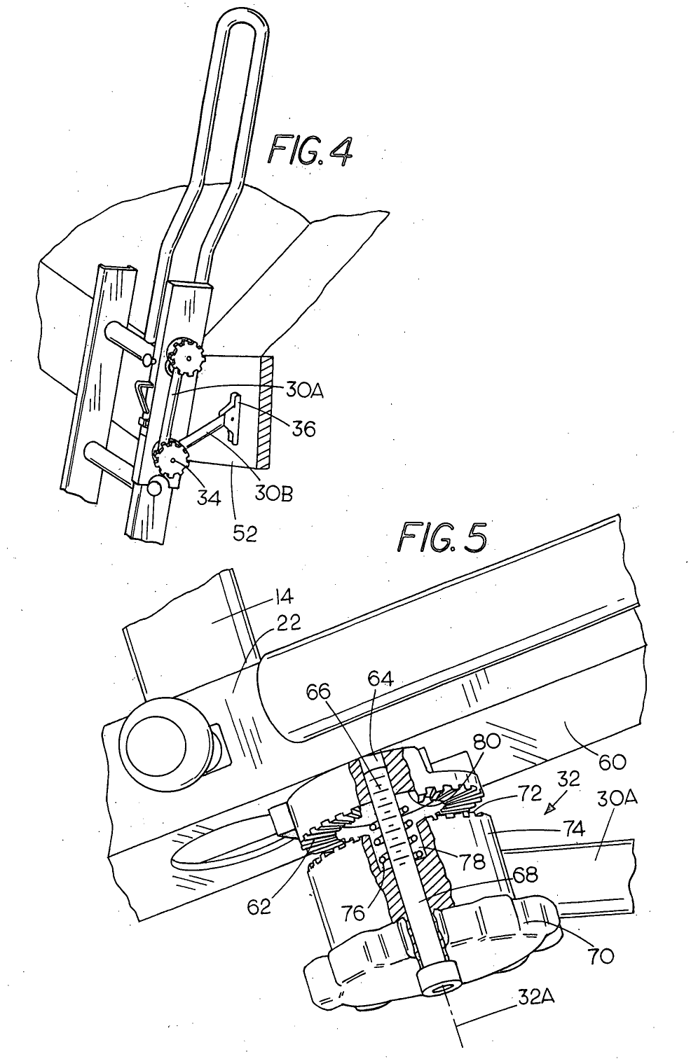

In some instances, it is desirable to have the foot support 36 against the vertical or side wall of the building, and this is illustrated in FIG. 4. A vertical wall 52 is shown, and the arm sections 30A and 30B are inclined about their pivot axes at the respective manually lockable angularly adjustable lock assembles 32 and 34, so that the foot support 36 bottom surfaces are substantially vertical and engaging the wall 52.

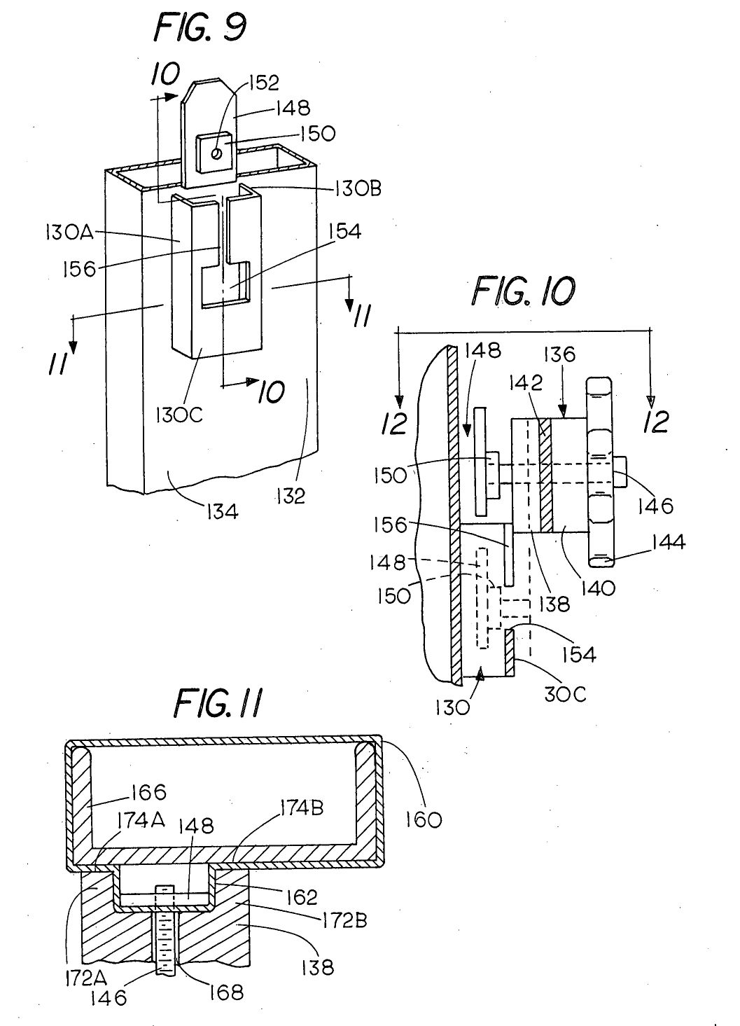

The manually lockable angularly adjustable locks 32 and 34 are capable of positively locking the angular position between the arm sections 30A and 30B, (as well as between arm section 30A and the ladder) and locking the parts in place. This is a quick adjustment, but is also a positive lock. This is achieved as shown in FIG. 5. The typical hand operated lock assembly block 32 at the mounting between the ladder and the base of arm section 30A includes a base section 60 that is fixed to the sleeve 22 that mounts the walk through assembly and thus the ladder. The base 60 can be mounted on the sleeve or ladder rail in any desired manner, including screws, welding or any secure mounting that holds the base 60 in position. A quick attachment device for a ladder anchor arm is shown in FIGS. 9-13, as well.

The base 60 has a front or outer face that has radially extending teeth illustrated at 62, positioned at desired intervals around the face of the base 60, and has a threaded bore 64 in the center. The threaded bore 64 receives a threaded end 66 of a screw 68 that is fixed to move with a hand wheel 70. The hand wheel 70 has the screw 68 securely anchored to the had wheel. The screw 68 is of sufficient length so that it can extend through the arm base hub 74 that supports arm section 30A and into the threaded bore 64 before the teeth 62 engage spacings between mating teeth 72 of the face of the arm base hub 74.

The screw 68 and the hand wheel 70 can be rotated to move the arm base hub 74 and the teeth 72 on the hub 74 toward the teeth 62 on the arm base hub 74. As shown, a spring 76 is mounted in a center counterbore 78 on the outer end of the hub 74. It can be noted that the teeth 62 and 72 do not extend all the way to the axis of the respective face, but leave the center portions without teeth so that the spring 76 can operate against a surface 80 of the base 60 and be retained in the counterbore 78. The spring 76 will be selected in strength so that it will tend to urge the arm base hub 74 and base 60 apart. When the hand wheel is rotated in one direction, the arm base hub 74 and base 60 separate, and the teeth 62 and 72 are disengaged so that the arm section 30A, as well (as the arm section 28A, when released) can be rotated about the axis shown at 32A. Axis 32A is the axis of pivot between the ladder and both arm assemblies 28 and 30.

The hand wheel 70 can be rotated to turn the capscrew 68, because the hand wheel is secured to the capscrew. The capscrew 68 will rotate in an opening or bore in the hub 74 so that the screw 68 can be backed out of the threaded bore 64 in the base 60 for moving the teeth 62 and 72 apart. The capscrew 68 can be rethreaded to lock the teeth 62 and 72 at the desired angular position of the arm section 30A.

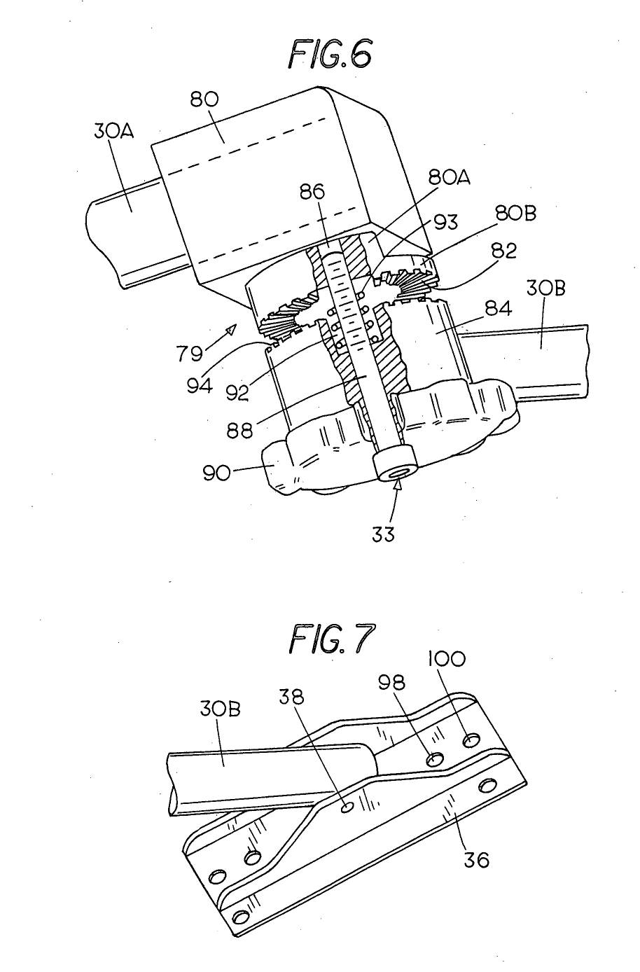

In FIG. 6, the manually lockable angularly adjustable pivot assembly 79 that is illustrated is the one that is used between the arm sections, at the elbow joint 33, and in this form of the disclosure, the arm section 30A is anchored in a center joint hub 80, in a suitable manner, such as in a bore in the hub 80. The center joint hub 80 includes a portion 80A which carries a flange 80B on which radially extending teeth shown at 82 are formed. The arm section 30B (and thus the arm section 28B as well) is mounted in an arm hub 84 in a manner similar to the mounting of the arm section 30A to hub 74 and the hub 80.

Here, also, the hub portion 80A has a threaded bore 86 that receives a threaded end of a capscrew 88. The capscrew 88 passes through a bore in the arm hub 84, and is secured to a hand wheel 90 that will rotate the capscrew, to thread in the bore 86 and permit the hub 84 to be moved toward or away from the flange 80B as the hand wheel 90 is rotated. In this pivot assembly as well, the hub 84 has a counterbore 92 that receives a spring 93, and the spring 93 bears against the outer surface of the flange 80B so that it will tend to separate the flange 80B and arm hub 84, so that the teeth 82 on the flange 80B and the facing teeth 94 on the hub 84 will disengage, or engage depending on the direction of rotation of the hand wheel 90. The teeth 82 and 94 on both of the angular adjustment hubs, positively engage when the hubs are moved together because the teeth are cut to fit between spaces of the facing teeth 82 or 94 and prevent any rotation when the hand wheel 90 is tightened so that the teeth engage. This gives a positive angular adjustment, even under substantial loads on the stabilizing or anchor arms.

As shown in FIG. 7 the support or foot member 36 is shown mounted onto arm section 30B, and it has a number of apertures 98 therein into which a nail, screw or other member shown, the head of which is shown at 100, can be secured to a wall, roof or soffit for further stability. The pivot axis 38 is shown in FIG. 7 as well.

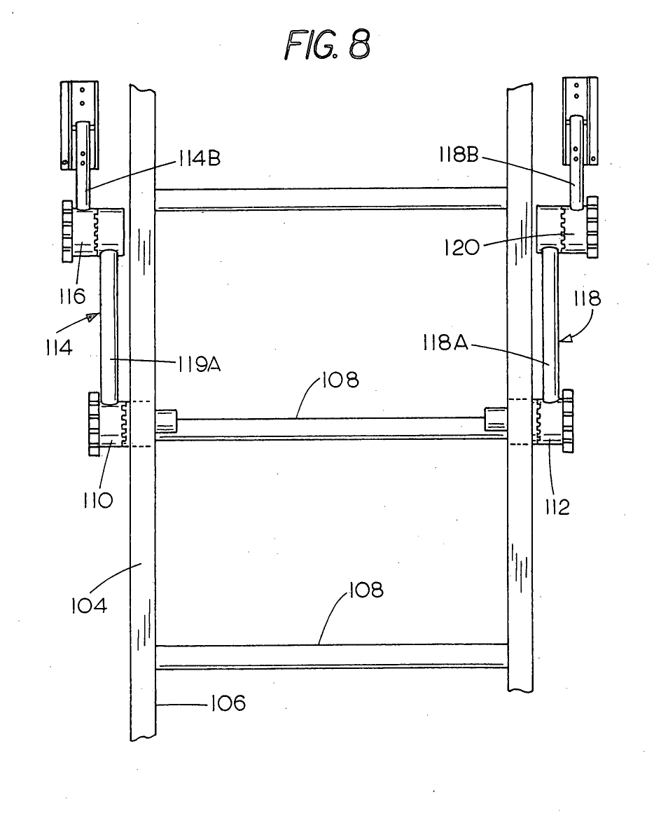

In FIG. 8, a modified structure is shown schematically for illustrative purposes. The ladder anchor is mounted onto a conventional extension ladder without using the walk through members illustrated in FIG. 1. This ladder 104 includes side rails 106, and rungs 108 in a conventional manner. The rungs generally are hollow in extension ladders, and can be used for passing an elongated rod through the rungs if desired, to secure a pair of the manual adjustment hub assemblies, such as those illustrated in the previous form of the disclosure but indicated here at 110 and 112.

In this form of the invention, an arm assembly 114 includes arm sections 114A and 114B, joined with a manually lockable angularly adjustable device 116, and the arm assembly 118 on the opposite side of the ladder includes an arm section 118A, and an arm section 118B that are joined with a manually lockable angularly adjustable device 120 that is identical to those which are shown in the previous FIGS.

These manually lockable angularly adjustable pivot support devices have hand wheels, as shown, and they include the toothed locks that are shown in the previous FIGS. However, the mounting directly to the ladder can be modified as desired and makes the ladder anchor or stabilizer available for all types of ladder. While a cross rod through hollow ladder rungs can be used for joining the manual angle adjustment devices 110, 112, to secure them in place, the adjustment device can be secured onto ladder rails in any other manner that is desired, such as with screws, rivets, brazing, welding or the like so long as the strength integrity of the ladder is not adversely affected.

A quick attachment device for mounting the ladder anchor arm assemblies onto either a ladder side rail or a sleeve for a walk through device is illustrated in FIGS. 9-13 as a modified form of mounting the ladder anchor arms. The ladder anchor arms are not shown in detail in FIGS. 9-13, but would be constructed as previously shown. In this case, an attachment bracket 130 is shown attached to a ladder extension sleeve 132 that is made in the same manner as the sleeves 20 and 22 in the first form of the disclosure, to be placed in approximately the same vertical location as that shown in FIGS. 1-4.

The bracket 130 can be secured or welded to the side wall 134 of the sleeve 132 as shown in FIG. 9, or as can be seen, in FIGS. 11-13, the bracket can be formed outwardly along the length of the sleeve so that the sleeve and bracket can be extruded as one unit.

When the bracket 130 is installed on the ladder side rail directly, it can be secured to the wall of the side rail in a desired manner, but would likely have an extra flange for bolting it to the side rail or some attachment similar. The bracket 130 is made to provide a way of mounting the angular lock assembly for each of the ladder anchor arms onto the ladder side rails, the side rail sleeves are used for making the mounting to the ladder side rails when a walk through attachment is included. The bracket will permit removing the angularly adjustable anchor arms when the ladder anchor arms are not to be used for a time.

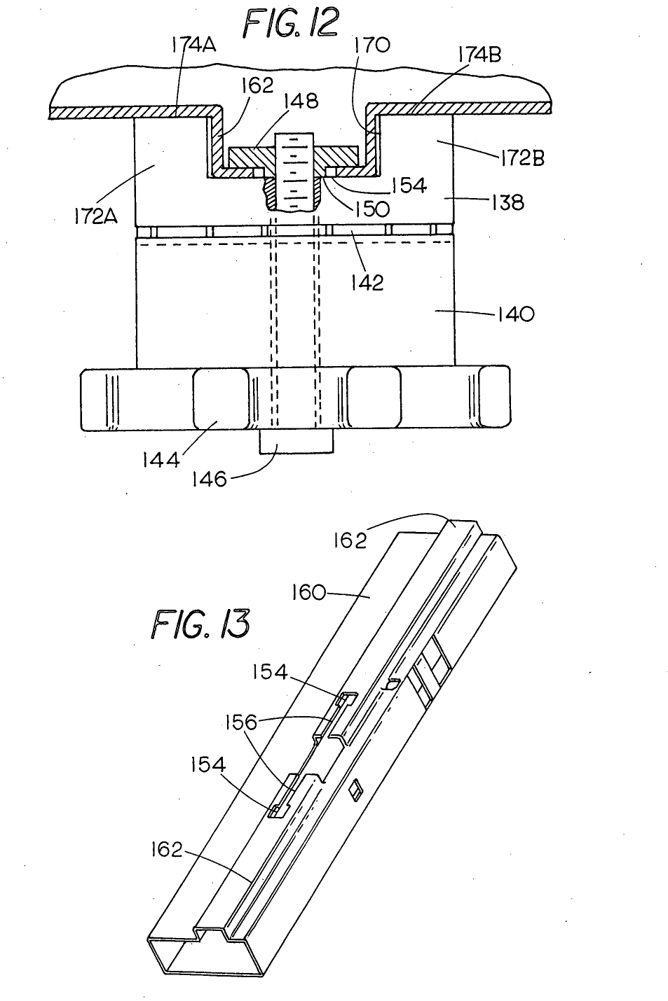

Referring to FIGS. 9-13, a manually lockable angularly adjustable lock assembly indicated at 136 is constructed in the same manner as in the previous forms of the disclosure, and includes a base section 138 (refer to FIGS. 10 and 12), an arm support hub section 140. The base section and hub sections have interfitting teeth shown schematically at 142, that are made as previously disclosed in the specification.

A hand wheel 144 carries a capscrew 146 which rotates with the hand wheel. In this form of the disclosure, the capscrew 146 passes through a clearance bore in the hub sections 140 and base section 138, and does not thread into the base section. Instead, in order to provide for quick attachment and removal of the anchor arms, the capscrew 146 threads into a separate lock tab 148. It also should be noted that the hub section 140 of the adjustable lock assembly 136 carries a ladder anchor base arm section, such as arm section 30A. The arm sections are not shown in FIGS. 8-13 for sake of clarity.

The lock tab 148 is of size to slide between the side legs 130A and 130B of a bracket 130, and fit closely between the legs 130A and 130B so the lock tab will swivel, or twist. The lock tab 148 also fits between an outer wall 130C of the bracket and a side wall 134, which provides mounting to the ladder. The lock tab 148 has a square lock block 150, and a threaded bore 152 to receive the capscrew 146. The lock block 150 is of size to fit within a key hole type lock opening 154 that is formed in the outer wall 130C of the bracket 130.

A slot 156 in the outer wall 130C extends from the lock opening 154 up to the top of the lock bracket. The slot 156 is of size to permit the capscrew 146 to slide along the slot when the capscrew is threaded into the bore 152 and there is a space between the lock tab 148 and the end of base section 138. The slot 156 and opening 154 are called a key hole type slot. This is illustrated in FIG. 10, where the lock tab 148 is positioned above the lock bracket 130, that is shown in section. It can be seen that the lock block 150 is spaced from the inner surface of the base section 138 of the lock assembly 136 more than the thickness of the wall 130C so that the base section 138 can be slid downwardly along the outer side of the outer wall 130C. The capscrew 146 will pass along the slot 156 to position lock block 150 in alignment with the opening 154.

Then, the hand wheel 144 and capscrew 146 are threaded to tightly clamp the outer wall 130C of the bracket 130 in position with the lock block secured in the opening 156 so the hub base section 138 cannot rotate because of the outer configuration of the lock block 150 and the opening 154.

In FIGS. 11-13, a modified extruded sleeve 160 is shown and a bracket 162 is extruded in place along one side wall of the sleeve 160. The bracket 162 has an outer wall with a lock opening and slot as that shown in FIG. 9. The difference is that the bracket 162 would be formed along the length of the sleeve so that extrusion of the sleeve was possible. The openings 154 and slot 156 can be punched in place either before or after extrusion. The sleeve 160 can have opposite facing slots and square lock openings as shown in FIG. 13 for illustrative purposes, so that it can be used for either side of the ladder. The slots, square openings, and the space between the two brackets 162 can be pre-punched before the parts are extruded.

In FIG. 11, a ladder side rail indicated at 166 is illustrated illustratively, with the sleeve 160 on the outside of the rail. In this form, the base section 138 of the lock assembly is illustrated with the bore 168 through which the capscrew 146 extends, with the lock tab 148 shown in position in the extruded lock bracket 162.

In FIGS. 11 and 12, the configuration of the base section 138 of the lock assembly 136 is illustrated. It can be seen that the base section 138 has a recess 170 that is of size to form two separate legs 172A and 172B that straddle the lock bracket portion 162, and have end surfaces 174A and 174B that will engage and abut against the outer surface of the side wall of the sleeve 160, when the lock tab 148 is tightened securely. The adjustable lock assemblies are held very securely on the lock brackets, whether the brackets are separately made and secured in place as shown in FIG. 9 or as part of an extruded form shown in FIGS. 11-13.

In FIG. 12, the lock block 150 is shown in position in the outer wall in the opening 154 in the outer wall of the extruded section 162.

When the capscrew 146 is loosened, the locking teeth illustrated only at 142 will separate and disengage and the outer hub 140 that carries the anchor arms can be rotated to move the arm section that is fixed to the hub 140 to its desired position as previously explained.

Again, the base anchor arm section will be secured to the hub 140 of the lock assembly 136, and would operate in the same manner as previously explained.

The mounting bracket 130 and 162 shown in FIGS. 9-13 permit removal of the anchor arm sections quickly and easily, but yet they will securely hold the arm sections when the hand wheels are tightened down. The square lock block 150 and mating opening 154 resist rotation of the mounting hubs. Other irregular peripheral shapes can be used as well to resist rotation of the hubs.

Other manually lockable angularly adjustable locks can be used for engaging and disengaging the angular adjustable teeth. For example, cam operators can be used in place of hand wheels, or spring loaded locks that hold the locking teeth together under spring pressure.

Although the present invention has been described with reference to preferred embodiments, workers skilled in the art will recognize that changes may be made in form and detail without departing from the spirit and scope of the invention.

What is claimed is:

1. A ladder anchor for use with a ladder having side rails and rungs joining the side rails, at least one arm supportable on one of the side rails of the ladder adjacent an upper end thereof, the arm having first and second arm sections, a first end of the first arm section having a first pivot support for pivotally mounting the first arm section relative to the one side rail, a second pivot support between a second end of the first arm section and a first end of the second arm section, a surface engaging support at a second end of the second arm section, said surface engaging support having a pivotal mounting to the second arm section about a generally horizontal pivot, and a separate adjustable pivot connection at each of the first and second pivot support connection mounted between the side rail of the ladder and a second of the arm sections.

2. The ladder anchor of claim 1 wherein the adjustable pivot connections each comprise a pair of relatively pivotable hub portions, each of the hub portions having a toothed surface facing a toothed surface of the other hub portion, and an actuator movable to releasably lock the teeth on the toothed surfaces together to hold the hub portions in a desired angular position.

3. The ladder anchor of claim 2 and a spring acting between the hubs of the pair of hubs tending to move the hubs forming the pair of hubs apart.

4. The ladder anchor of claim 2, wherein the actuator comprises a rotatable hand wheel having a screw for threadably moving the hubs of the pair of hubs toward each other to a locked position.

4. The ladder anchor of claim 4 and a spring acting between the hubs of the pair of hubs urging the hubs of the pair of hubs to separate, the spring having strength to move to hubs apart when the screw is threadably moved in a direction away from the locked position.

5. The ladder anchor of claim 1, wherein the first pivot support comprises a second manually adjustable pivot support comprising a pair of relatively pivotable hub portions, each of the hub portions having a toothed surface facing a toothed surface of the other of the hub portions, and a manually actuator actuatable to lock the interfitting toothed surfaces together to hold the hub portions in a desired angular position.

7. The ladder anchor of claim 6, wherein the arm sections are substantially straight tubular sections.

8. The ladder anchor of claim 2 wherein each of the pivot supports permits substantially 360° of rotation between the respective hub portions.

9. A ladder anchor assembly for use of the ladder having side rails, and rungs joining the side rails, an arm assembly mountable on at least one of the side rails of the ladder adjacent an upper end thereof, the arm assembly having first and second arm sections, a first manually lockable angularly adjustable pivot support having a first portion for mounting to a ladder and a second portion connected to a second manually lockable adjustable pivot suppport between a first end of a first arm section, and between a second end of the first arm section and a first end of the second arm section, a surface engaging support at a second outer end of the second arm section for engaging a surface of a building for providing lateral support for a ladder.

10. The ladder anchor of claim 9, and a hand screw for manually locking the manually lockable angularly adjustable pivot supports.

11. The ladder anchor of claim 9 wherein said portions of said first manually lockable angularly adjustable pivot support between the first end of the first arm section and a ladder side rail have facing toothed surfaces that are moved together to lock the portions in a pivotal position.

12. The ladder anchor of claim 9 wherein the first manually lockable angularly adjustable pivot support comprises a hand screw that tightens the two portions of the first manually lockable angularly adjustable pivot support together when turned a first direction, and loosens an interface between the two portions of the first manually lockable angularly adjustable pivot support when the hand screw is turned in an opposite direction.

13. The ladder anchor of claim 9 wherein both the manually lockable angularly adjustable pivot supports have two portions with facing surfaces generally concentric about an axis of pivot of the respective manually lockable angularly adjustable pivot support, the facing surfaces of each of the manually lockable angularly adjustable pivot supports having teeth projecting toward the surface of the other manually lockable angularly adjustable pivot support, and the teeth on each surface being spaced to interfit when the facing surfaces are moved together.

14. The ladder anchor of claim 13 wherein the manually lockable angularly adjustable pivot supports pivot about substantially parallel axes.

15. The ladder anchor of claim 14 wherein said substantially parallel axes are generally horizontal when the ladder anchor is installed on a ladder.

16. The ladder anchor of claim 9 wherein the surface engaging support at the second end of the second arm section comprises a foot pivotally mounted to the second end of the second arm section about an axis parallel to the axes of the manually lockable angularly adjustable pivot supports.

17. The ladder anchor of claim 9, and a bracket fixed with respect to a ladder side rail, said bracket having a wall spaced outwardly from a surface that is fixed relative to a ladder side rail, a key hole type slot in the wall of the bracket, a capscrew extending through the two portions of the first adjustable pivot supports, a lock tab carried by the capscrew, said lock tab being positionable on opposite side of the wall of the bracket from the manually lockable angularly adjustable pivot support and being clampable against the first wall bu tightening the capscrew to hold the first manually lockable angularly adjustable pivot support on the bracket.

18. The ladder anchor of claim 17 wherein the key hole type slot has a rectilinear end opening section and a narrower access slot joining the opening, and the tab has a mating rectilinear block that fits into the end opening when the capscrew is tightened to move the first manually lockable angularly adjustable pivot support against the wall of the bracket.

19. The ladder anchor of claim 18, wherein the first portion that has a recess forming two legs which engage a wall supporting the bracket when the capscrew is tightened and the bracket fitting between the two legs.
